(19) United States
(12) Patent Application Publication
(10) Pub. No.: US 2017/0248465 A1
(43) Pub. Date: Aug. 31, 2017

(54) LIGHT ENHANCEMENT DEVICE, MANUFACTURING METHOD OF THE SAME, KIT FOR SPECTROSCOPIC ANALYSIS, AND SPECTROSCOPIC ANALYSIS METHOD

(71) Applicants: NISHIMATSU CONSTRUCTION CO., LTD., Tokyo (JP); ITO RESEARCH INSTITUTE CO., LTD., Fujisawa-shi (JP)

(72) Inventors: Kengo ITO, Fujisawa-shi (JP); Naohiro TAKEDA, Fujisawa-shi (JP)

(73) Assignees: NISHIMATSU CONSTRUCTION CO., LTD., Tokyo (JP); ITO RESEARCH INSTITUTE CO., LTD., Fujisawa-shi (JP)

(21) Appl. No.: 15/434,265

(22) Filed: Feb. 16, 2017

(30) Foreign Application Priority Data
Feb. 29, 2016 (JP) 2016-036899

(51) Int. Cl. G01J 3/02; B05D 1/18; B05D 3/06; G02B 1/14

(52) U.S. Cl. CPC G01J 3/0205; G02B 1/14; B05D 1/18; B05D 3/06; Y10S 977/777; B82Y 20/00

(57) ABSTRACT

The object of the present invention is to provide a novel light enhancement device manufactured easily. According to the present invention, there is provided a light enhancement device including a substrate provided with an adsorption layer formed on its surface and including a hydrophobic modified clay with organic compound; and tabular silver nanoparticles oriented and adsorbed on the adsorption layer. Furthermore, there is provided a manufacturing method of a light enhancement device including a step of forming an adsorption layer including a hydrophobic modified clay with organic compound on a surface of a substrate; and a step of immersing the substrate in an aqueous dispersion of tabular silver nanoparticles. Furthermore, there is provided a kit for spectroscopic analysis including a substrate provided with an adsorption layer including a hydrophobic modified clay with organic compound formed on its surface; and a container filled with an aqueous dispersion of tabular silver nanoparticles.

### CROSS REFERENCE TO RELATED APPLICATION

This application is based upon and claims the benefit of priority under 35 USC 119 of Japanese Patent Application No. 2016-036899 filed on Feb. 29, 2016 the entire disclosures of which, including the descriptions, claims, drawings and abstracts, are incorporated herein by reference in their entirety.

### BACKGROUND OF THE INVENTION

1. Field of the Invention

The present invention relates to a light enhancement device, in particular, a light enhancement device using tabular silver nanoparticles.

2. Description of Related Art

Highly sensitive detection of a very small amount of substance is conventionally performed using Surface Enhance Raman Spectroscopy (SERS) and Surface Plasmon-field enhanced Fluorescence Spectroscopy (SPFS). Both of them are examples of spectroscopic analysis methods including enhancement and measurement of weak light (for example, Raman scattering light or fluorescence) in an enhanced electric field induced by Localized Surface Plasmon Resonance (LSPR).

Provided in recent years are various types of light enhancement devices in which LSPR appear, such as a device including a substrate having a surface evaporated with island-shaped metal nanoparticles, a device including a substrate on which rough structure in an order of nanometers is formed, and the like (for example, see Japanese Unexamined Patent Application Publication No. 2013-148421).

Since conventional manufacturing method of a light enhancement device uses techniques such as lithography, spattering, and vacuum evaporation in order to form a nanostructure for LSPR, large equipment and complicated processes are required and the cost cannot be suppressed for manufacturing a light enhancement device.

### SUMMARY OF THE INVENTION

### Problems to be Solved by the Invention

An object of the present invention, which has been accomplished to solve the problem of the conventional method, is to provide a novel light enhancement device which can be manufactured easily.

### Means for Solving the Problems

As a result of intensive studies of a novel light enhancement device which can be manufactured easily, the present inventors conceived of the following constitution and arrived at the present invention.

According to the present invention, there is provided a light enhancement device including: a substrate provided with an adsorption layer formed on a surface of the substrate, wherein the adsorption layer includes a hydrophobic modified clay with organic compound; and tabular silver nanoparticles oriented and adsorbed on the adsorption layer.

Furthermore, according to the present invention, there is provided a manufacturing method of a light enhancement device including: a step of forming an adsorption layer on a surface of a substrate wherein the adsorption layer includes a hydrophobic modified clay with organic compound; and a step of immersing the substrate provided with the adsorption layer in an aqueous dispersion of tabular silver nanoparticles.

Furthermore, according to the present invention, there is provided a kit for spectroscopic analysis including: a substrate provided with an adsorption layer formed on a surface of the substrate wherein the adsorption layer includes a hydrophobic modified clay with organic compound; and a container filled with an aqueous dispersion of tabular silver nanoparticles.

Furthermore, according to the present invention, there is provided a spectroscopic analysis method of a sample, including: a step of putting the sample into an aqueous dispersion of tabular silver nanoparticles; a step of immersing a substrate in the aqueous dispersion including the sample, wherein the substrate is provided with an adsorption layer formed on a surface of the substrate, the adsorption layer includes hydrophobic modified clay with organic compound, and the silver nanoparticles are oriented to and adsorbed by the substrate through the adsorption layer; a step of irradiating a region in which the silver nanoparticles are oriented and adsorbed with excitation light; and a step of measuring a spectrum of light emitted from the region.

### BRIEF DESCRIPTION OF THE DRAWINGS

FIG. 1 is a flow chart illustrating the steps of manufacturing a light enhancement device according to an embodiment of the present invention;

FIG. 2 is a schematic diagram illustrating preparation of tabular silver nanoparticles;

FIG. 3 shows the absorption spectra of aqueous dispersions of tabular silver nanoparticles;

FIG. 4 shows the absorption spectra of a light enhancement device according to an embodiment of the present invention;

FIG. 5 shows the Raman spectra of 4,4′-bipyridine measured with a light enhancement device according to an embodiment of the present invention.

### DESCRIPTION OF THE PREFERRED EMBODIMENT

The present invention will now be described with reference to the embodiments shown in the attached figures. The embodiments shown in the attached figures should not be construed to limit the present invention.

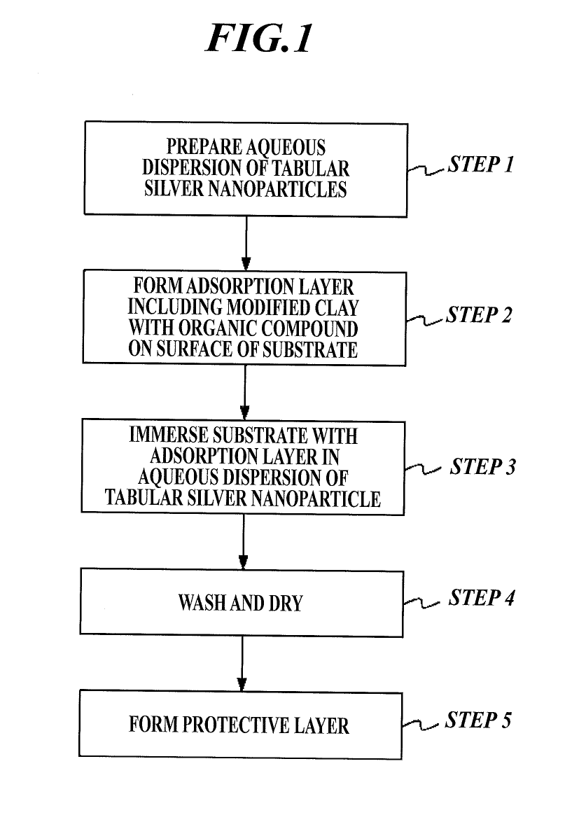

First, a manufacturing method of a light enhancement device according to an embodiment of the present invention will be described with reference to FIG. 1.

In Step 1, an aqueous dispersion of tabular silver nanoparticles is prepared by liquid-phase reduction. It is known that the wavelength range of light absorption and scattering caused by LSPR depends on the crystal size of tabular silver nanoparticles; hence, the crystal size of the tabular silver nanoparticles should be controlled in Step 1 to obtain a light absorption range required for a light enhancement device.

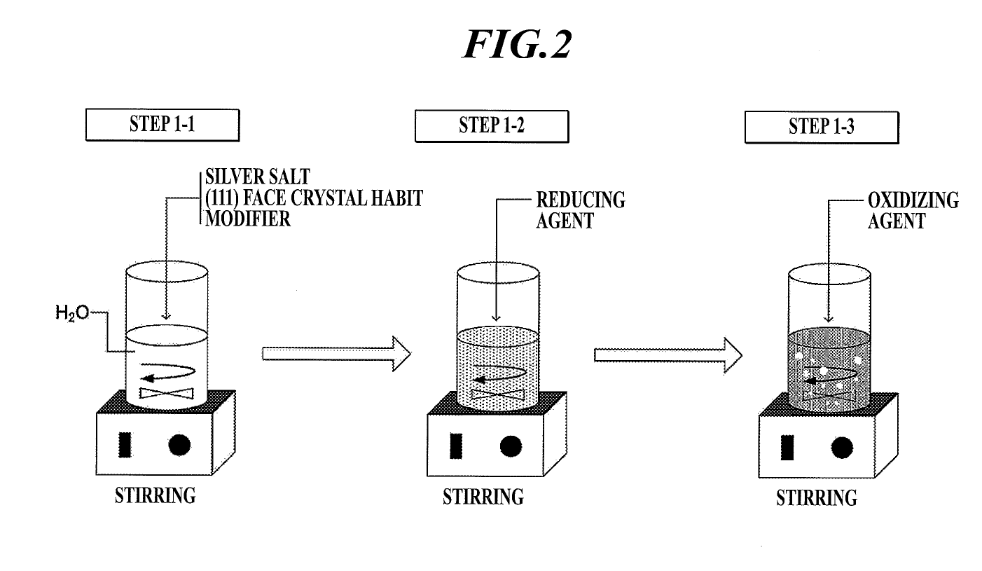

With reference to FIG. 2, a preferred method of preparing an aqueous dispersion of tabular silver nanoparticles will now be described.

In Step 1-1, a silver ion aqueous solution including a crystal habit modifier is prepared. Specifically, a silver salt such as silver nitrate (AgNO₃) and a crystal habit modifier are added to vigorously stirred water (preferably pure water, more preferably ultrapure water) to prepare the silver ion aqueous solution including the crystal habit modifier. A preferred example of the crystal habit modifier used in the present embodiment is citric acid, which can be selectively adsorbed on the (111) face of silver crystals.

In subsequent Step 1-2, while the silver ion aqueous solution described above is being vigorously stirred, a reducing agent is added. The added reducing agent reduces silver ions in the aqueous solution to generate very fine silver seed crystals. A typical example of the reducing agent usable in the present embodiment is sodium tetrahydroborate (NaBH₄).

In subsequent Step 1-3, while the resulting aqueous dispersion including fine silver crystals obtained in Step 1-2 described above is being vigorously stirred, an oxidizing agent is added. A preferred example of the oxidizing agent usable in the present embodiment is hydrogen peroxide (H₂O₂). The addition of the oxidizing agent gives rise to an increase in solubility of metal silver in the aqueous dispersion and promotes partial reionization of fine silver crystals. In order to constantly keep a certain level of silver ions in the reaction system over the process, the oxidizing reagent is intermittently added in several times or is continuously added while its flow rate is being controlled. Ostwald ripening proceeds under such condition, accelerating selective growth of larger crystals and disappearance of smaller crystals. As a result, tabular silver nanoparticles with an increased diameter in the principal plane are manufactured as a main component in the reaction system.

The resulting tabular silver nanoparticles with enlarged sizes have an absorption band in the visible to near-infrared region due to LSPR. In the present embodiment, the crystalline sizes of the tabular silver nanoparticles can be controlled by adjusting the concentrations of the silver ions and crystal habit modifier in Step 1-1 and the amount of reducing agent to be added, the stirring efficiency, and the reaction temperature in Step 1-2.

With reference to FIG. 1 again, the manufacturing method will be further described.

In subsequent Step 2, a substrate of an appropriate type is prepared and an adsorption layer including modified clay with organic compound is formed on a surface of the substrate. Examples of the material for the substrate are not limited to, but include silicone, glass, plastic, metal oxide, and the like.

In a first stage of Step 2, modified clay with organic compound is added with mixing and stirring to an organic solvent such as toluene to prepare an organic dispersion of the modified clay with organic compound. The modified clay with organic compound represents clay (phyllosilicate) of which interlayer cations are replaced with organic cations, and is preferably smectite. It is preferred to use modified clay with organic compound having high hydrophobicity, which can be dispersed in organic solvents having high hydrophobicity such as toluene in a high concentration (several wt %). In the present embodiment, a charge transfer boron polymer with a nitrogen atom-boron atom complex structure may be added to the organic dispersion of the modified clay with organic compound.

Subsequently, a layer of modified clay with organic compound is formed by applying the prepared organic dispersion of the modified clay with organic compound on the surface of the prepared substrate by any proper method. The layer of modified clay with organic compound functions as an adsorption layer on which tabular silver nanoparticles are oriented and adsorbed. The layer of modified clay with organic compound is hereinafter referred to as an adsorption layer.

Steps 1 and 2 are described above in this order; however, Steps 1 and 2 may be performed in any order in the present invention.

In subsequent Step 3, the substrate provided with an adsorption layer prepared in Step 2 is immersed in the aqueous dispersion of tabular silver nanoparticles prepared in Step 1 for a certain time.

The modified clay with organic compound having high hydrophobicity adsorbed on the surface of the substrate is hydrophobic. The tabular silver nanoparticles have higher affinity with the modified clay with organic compound than water. As a result, the tabular silver nanoparticles are attracted to the modified clay with organic compound and are oriented to and adsorbed by the substrate by self-organization. The tabular silver nanoparticles are respectively plane-oriented without association or aggregation with each other, such that the principal plane of the nanoparticles is substantially parallel to the surface of the substrate. As a result, each of the tabular silver nanoparticles adsorbed by the substrate does not lose characteristics of a nanoparticle and LSPR continues to appear.

Additionally, a gap in an order of nanometers (hereinafter referred to as a nanogap) is formed between two of the tabular silver nanoparticles close to each other and adsorbed on the adsorption layer. The nanogap of the present embodiment is usually less than 100 nm, more preferably less than 50 nm. The nanogap includes a minute gap formed between two tabular silver nanoparticles which are completely separated from each other on the substrate and a minute gap formed near the contact point between two tabular silver nanoparticles which are partly in contact with each other.

It is theoretically predicted that electric field induced by incident light is enhanced by 10⁵ to 10⁶ times near the contact point between two metal nanoparticles which appear LSPR. Tabular silver nanoparticles are arranged as densely as possible without aggregation on the substrate through a layer on which the tabular silver nanoparticles are oriented and adsorbed (hereinafter referred to as a tabular silver nanoparticle layer) and form many nanogaps. The nanogaps make the tabular silver nanoparticle layer function as a powerful electric field enhancement layer.

In subsequent Step 4, the substrate provided with the tabular silver nanoparticle layer is taken out from the aqueous dispersion of tabular silver nanoparticles, is thoroughly washed with water, and is completely dried.

Finally, in Step 5, a protective layer is formed to coat the tabular silver nanoparticle layer provided on the substrate when it is necessary to avoid interaction with the sample or quenching of fluorescence. The light enhancement device of the present embodiment is thereby obtained. Specifically, the protective layer can be formed by application of an organic dispersion of modified clay with organic compound to the tabular silver nanoparticle layer by any proper method. It is not necessary to use hydrophobic modified clay with organic compound for forming the protective layer. Hydrophobic or hydrophilic modified clay with organic compound can be selected depending on the samples or the fluorescent molecules used as a marker. The present embodiment does not limit the materials or forming method of the protective layer.

As described above, a light enhancement device having a powerful electric field enhancement layer can be manufactured at low cost according to the present embodiment by simply immersing a substrate provided with an adsorption layer of modified clay with organic compound in an aqueous dispersion of tabular silver nanoparticles.

The light enhancement device according to the present embodiment can be used in both Surface Enhance Raman Spectroscopy (SERS) and Surface Plasmon-field enhanced Fluorescence Spectroscopy (SPFS). Furthermore, according to the present embodiment, the absorption wavelength of the tabular silver nanoparticle layer can be adjusted to the wavelength of desired excitation light by controlling the size of the tabular silver nanoparticles in the tabular silver nanoparticle layer in Step 1 described above.

Furthermore, according to another embodiment, a kit for spectroscopic analysis is provided. The kit includes a substrate provided with an adsorption layer including hydrophobic modified clay with organic compound on its surface (hereinafter referred to as a substrate with an adsorption layer) and a container filled with an aqueous dispersion of tabular silver nanoparticles. The kit can be used for spectroscopic analysis as follows.

First, the aqueous dispersion of tabular silver nanoparticles in the container of the kit for spectroscopic analysis described above is transferred to an appropriate container (for example, a petri dish). A sample added to the appropriate container is dispersed in the aqueous dispersion.

Next, the substrate with an adsorption layer is immersed in the aqueous dispersion of tabular silver nanoparticles including the sample so that the tabular silver nanoparticles are oriented and adsorbed on the adsorption layer by self-organization.

Subsequently, a region in which the tabular silver nanoparticles are oriented and adsorbed is irradiated with excitation light and a spectrum of light emitted from the region is measured.

According to the spectroscopic analysis method described above, when the tabular silver nanoparticles are oriented and adsorbed on the adsorption layer by self-organization, a sample is located in nanogaps between two tabular silver nanoparticles close to each other. As a result, light (Raman scattering light or fluorescence) emitted from the sample can be preferably enhanced.

The embodiment of the present invention described above should not be construed to limit the present invention and any modification having the advantageous effect of the embodiment should also be included in the present invention as long as a person skilled in the art can readily conceive.

### EXAMPLES

The light enhancement device of the present invention will now be described in further details byway of the following examples, which should not be construed to limit the present invention.

### <Preparation of Aqueous Dispersion of Tabular Silver Nanoparticles>

Two kinds of tabular silver nanoparticles were prepared by the following procedure. All the reagents used were special grades available from Wako Pure Chemical Industries, Ltd.

### <Preparation of Tabular Silver Nanoparticles A>

While ultrapure water (148 ml) was being stirred, a 450 mM trisodium citrate aqueous solution (500 μl) and then 100 mM silver nitrate aqueous solution (150 μl) were added to the ultrapure water to prepare a starting solution. While the starting solution was being vigorously stirred, a 300 mM sodium tetrahydroborate aqueous solution (235 μl) was added as a reducing agent to the starting solution. A pale yellow aqueous dispersion including silver nanoparticles was thereby prepared.

Immediately after confirmation of coloring of the aqueous solution to pale yellow due to the addition of the reducing agent, 30% hydrogen peroxide water (360 μl) was added and stirring was continued. After approximately one hour stirring, the solution was further stirred for 24 hours under a milder stirring condition to yield an aqueous dispersion including silver nanoparticles A (silver concentration: 0.001 wt %).

### <Preparation of Tabular Silver Nanoparticles B>

While ultrapure water (125 ml) was being stirred, the aqueous dispersion (25 ml) including Tabular Silver Nanoparticles A prepared above and then a 50 mM ascorbic acid aqueous solution (150 μl) were added to the ultrapure water. While a 0.125 mM silver nitrate aqueous solution (300 ml) was being added at a rate of 3 ml/min, a 50 mM ascorbic acid aqueous solution (300 μl) was added in two parts. While a 0.250 mM silver nitrate aqueous solution (105 ml) was being added at a rate of 3 ml/min, a 50 mM ascorbic acid aqueous solution (315 μl) was added in two parts to yield an aqueous dispersion including Tabular Silver Nanoparticles B (silver concentration: 0.0013 wt %).

### <Measurement of Absorption Spectra of Aqueous Dispersion Including Tabular Silver Nanoparticles>

Absorption spectra of the aqueous dispersions including Tabular Silver Nanoparticles A and B were respectively measured with a spectrophotometer (v-670UV/Vis/NIR made by JASCO) where the path length of cell was 2 mm, and each aqueous dispersion was measured without dilution. Ultrapure water was used as a reference.

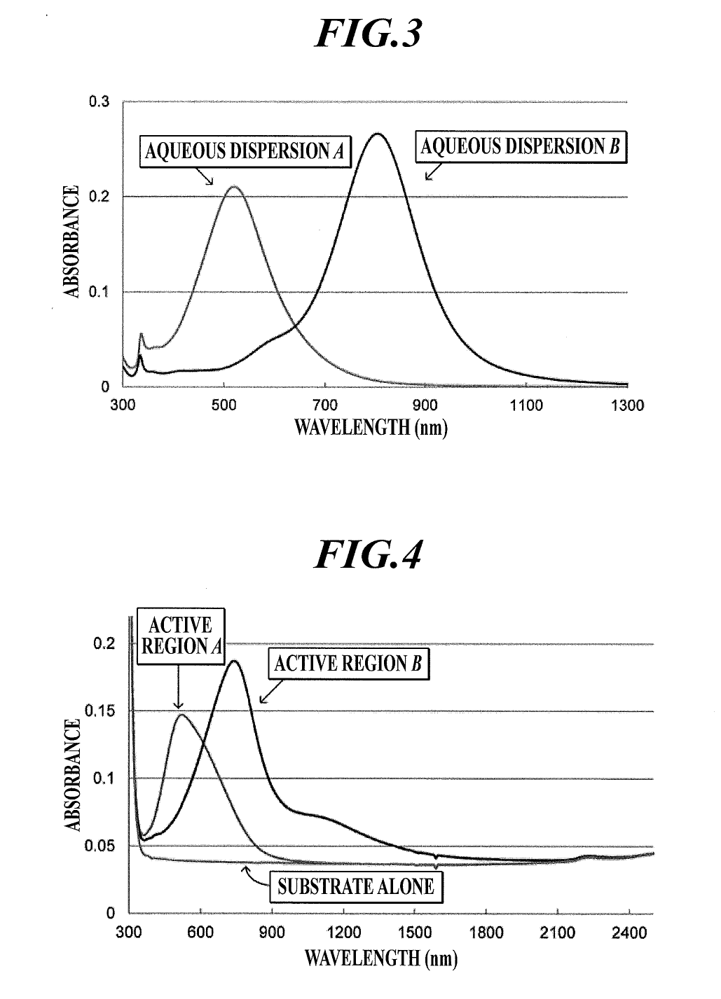

FIG. 3 shows the measured absorption spectra. No absorption band (approximately at 400 to 420 nm) assigned to non-tabular silver nanoparticles was found in the spectra of these aqueous dispersions. The results demonstrate that Tabular Silver Nanoparticles A and B consist substantially of tabular silver nanoparticles.

The spectra of the aqueous dispersions including Tabular Silver Nanoparticles A and B have maximum absorptions at 519 nm and 804 nm, respectively, due to LSPR. The diameters of the principal plane of the Tabular Silver Nanoparticles A and B determined from the maximum absorption wavelengths were inferred to be 40 to 50 nm and 100 nm, respectively.

### <Preparation of Light Enhancement Device>

0.05 wt % toluene dispersion of lipophilic synthetic clay (3.0 μl, Lucentite SAN available from Co-op Chemical Co. Ltd.) was dropped on a commercially available white slide glass for optical microscope. By drying the slide glass at room temperature, a circular coating of clay was formed on the surface of the white slide glass. The white slide glass was then immersed in the aqueous dispersion including Tabular Silver Nanoparticles A for 4 hours. After the immersion, the white slide glass was taken out and thoroughly washed with ultrapure water. After the remaining water was thoroughly removed, the white slide glasses were spontaneously dried to yield Light Enhancement Device A. By the same procedures, another white slide glass having a circular coating of clay was immersed in the aqueous dispersion including Tabular Silver Nanoparticles B, washed, and then dried to yield Light Enhancement Device B. It was visually confirmed that the region of circular coating formed on Light Enhancement Device A and Light Enhancement Device B exhibited colors arising from tabular silver nanoparticles. The circular region to which tabular silver nanoparticles are fixed is hereinafter referred to as an active region.

### <Measurement of Transmission Spectra of Light Enhancement Device>

Transmission spectra of an active region of Light Enhancement Device A (hereinafter referred to as Active Region A), an active region of Light Enhancement Device B (hereinafter referred to as Active Region B), and a substrate (a white slide glass) were measured with a spectrophotometer (v-670UV/Vis/NIR made by JASCO). Air was used as a reference.

FIG. 4 shows the measured transmission spectra. In comparison of the transmission spectra of Active Regions A and B shown in FIG. 4 with those of the aqueous dispersion including Tabular Silver Nanoparticles A and B shown in FIG. 3 respectively, these spectra significantly resemble each other in the wavelength region and in the band shape. These results evidentially demonstrate that LSPR is maintained in both Active Regions A and B.

<Raman Spectra of 4,4′-Bipyridine Measured with Light Enhancement Device>

0.32 mM 4,4′-bipyridine aqueous solution (50 μl) was dropped as a sample in Active Regions A and B, respectively. After leaving at rest for about 5 minutes and blowing excess aqueous solution away, the devices were completely dried. It was visually confirmed that the color tone in the active regions was not changed by adding 4,4′-bipyridine aqueous solution. Subsequently, excitation laser (wavelength: 785 nm) was focused on Active Regions A and B respectively to measure Raman spectra of Active Regions A and B with a Raman spectrophotometer (DXR Smart Raman Spectrometer made by Thermo Scientific). A Raman spectrum of 0.32 mM 4,4′-bipyridine aqueous solution alone was also measured under the same conditions.

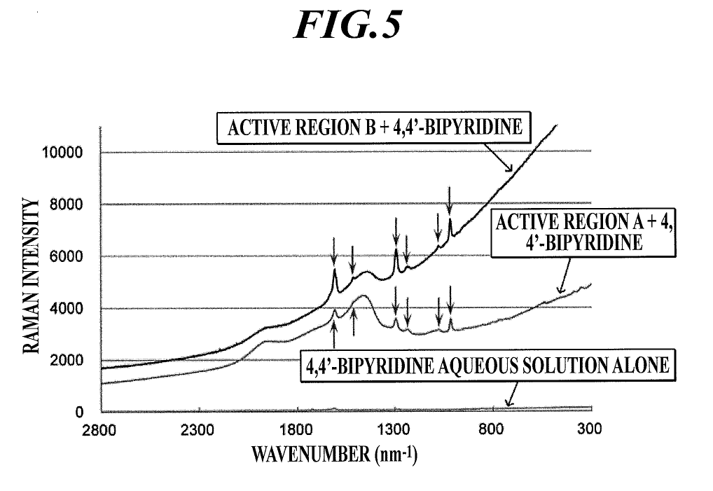

FIG. 5 shows the measured Raman spectra. While vibration band due to 4,4′-bipyridine was not observed in the Raman spectrum of the aqueous solution alone, a number of vibration bands were clearly observed in the Raman spectra of Active Regions A and B, respectively. The bands are indicated by arrows in FIG. 5. For comparison, Raman spectrum of a cast film formed by dropping the 4,4′-bipyridine aqueous solution directly on a white slide glass used as the substrate was measured. A vibration band due to 4,4′-bipyridine was also not observed in the Raman spectrum of the cast film as in that of the aqueous solution alone.

It was demonstrated from the above-described measured Raman spectra that the light enhancement device according to the present invention could effectively enhance light.

What is claimed is:

1. A light enhancement device comprising:
a substrate provided with an adsorption layer formed on a surface of the substrate, wherein the adsorption layer comprises a hydrophobic modified clay with organic compound; and
tabular silver nanoparticles oriented and adsorbed on the adsorption layer.

2. The light enhancement device of claim 1, wherein a gap in an order of nanometers is formed between two of the silver nanoparticles close to each other and adsorbed on the adsorption layer.

3. The light enhancement device of claim 1, wherein a principal plane of the silver nanoparticles is oriented and is substantially parallel to the surface of the substrate.

4. The light enhancement device of claim 1, comprising a protective layer coating the silver nanoparticles.

5. The light enhancement device of claim 4, wherein the protective layer comprises modified clay with organic compound.

6. The light enhancement device of claim 1, wherein the adsorption layer comprises a charge transfer boron polymer.

7. A manufacturing method of a light enhancement device comprising:
a step of forming an adsorption layer on a surface of a substrate wherein the adsorption layer comprises a hydrophobic modified clay with organic compound; and
a step of immersing the substrate provided with the adsorption layer in an aqueous dispersion of tabular silver nanoparticles.

8. The manufacturing method of a light enhancement device of claim 7, wherein in the step of forming the adsorption layer, an organic dispersion of the modified clay with organic compound is applied on the substrate.

9. The manufacturing method of a light enhancement device of claim 7, wherein in the step of immersing the substrate in the aqueous dispersion, the silver nanoparticles are oriented and adsorbed on the adsorption layer by self-organization.

10. A kit for spectroscopic analysis comprising:
a substrate provided with an adsorption layer formed on a surface of the substrate wherein the adsorption layer comprises a hydrophobic modified clay with organic compound; and
a container filled with an aqueous dispersion of tabular silver nanoparticles.

11. A spectroscopic analysis method of a sample comprising:
a step of putting the sample into an aqueous dispersion of tabular silver nanoparticles;
a step of immersing a substrate in the aqueous dispersion including the sample, wherein the substrate is provided with an adsorption layer formed on a surface of the substrate, the adsorption layer comprises hydrophobic modified clay with organic compound, and the silver nanoparticles are oriented to and adsorbed by the substrate through the adsorption layer;
a step of irradiating a region in which the silver nanoparticles are oriented and adsorbed with excitation light; and
a step of measuring a spectrum of light emitted from the region.
